(19) United States
(12) Patent Application Publication
(10) Pub. No.: US 2026/0106552 A1
(43) Pub. Date: Apr. 16, 2026

(54) DC VOLTAGE CONVERTER, ELECTRIC VEHICLE AND METHOD FOR OPERATING A DC VOLTAGE CONVERTER

(71) Applicant: Robert Bosch GmbH, Stuttgart (DE)

(72) Inventor: Jian Tian, Eutingen (DE)

(21) Appl. No.: 19/115,310

(22) PCT Filed: Jul. 12, 2023
(86) PCT No.: PCT/EP2023/069279

§ 371 Date: Mar. 26, 2025

(30) Foreign Application Priority Data
Sep. 27, 2022 (DE) 10 2022 210 190.1

(51) Int. Cl. H02M 3/335; B60L 50/60; H02M 1/088

(52) U.S. Cl. CPC H02M 3/33561; B60L 50/60; H02M 1/088; H02M 3/33571; B60L 2210/12; B60L 2210/30

(57) ABSTRACT

DC voltage converter having three DC voltage connections. The DC voltage converter can exchange electrical energy between the three DC voltage connections in any desired way. The DC voltage converter comprises a resonant circuit for resonant operation. In addition, a combination of an H-bridge circuit and a step-down converter is provided on at least one DC voltage converter connection.

### BACKGROUND

The present invention relates to a DC voltage converter and to an electric vehicle with such a DC voltage converter. The present invention also relates to a method for operating a DC voltage converter. In particular, the present invention relates to a DC voltage converter with three DC voltage connections.

The electrical on-board system of a fully or at least partially electrically powered vehicle usually comprises a high-voltage system and a low-voltage system. The high-voltage system usually has an electrical DC voltage in the region of several hundred volts. The low-voltage system usually has a significantly lower electrical DC voltage, for example in the range of 12 to 14, 24 or 48 volts. Typically, the high-voltage system supplies power to the electric drive system of such a vehicle and, where applicable, to other high-power consumers. The low-voltage system usually supplies power to consumers such as lighting, control units, brake and steering actuators or an entertainment system in the vehicle.

The high-voltage system and the low-voltage system can be coupled to one another by means of a DC voltage converter, for example. Such a DC voltage converter can be used to exchange electrical energy between the high-voltage system and the low-voltage system. In this way, for example, electrical consumers in the low-voltage system can be supplied with electrical energy from a traction battery in the high-voltage system.

For example, the publication DE 10 2014 210 283 A1 describes a method for operating a vehicle electrical system with at least two voltage levels that have different nominal voltages.

Furthermore, such an electric vehicle may be provided with an additional voltage converter that converts an electrical voltage at the charging connection of the vehicle into a DC voltage that is suitable for charging the traction battery of the electric vehicle.

### SUMMARY

The present invention provides a DC voltage converter, an electric vehicle, and a method for operating a DC voltage converter having the features of the independent claims. Further advantageous embodiments are the subject matter of the dependent claims.

The following is therefore provided:

A DC voltage converter comprising a transformer, a first H-bridge circuit, a second H-bridge circuit, a voltage converter circuit and an resonant circuit. The transformer comprises a primary winding, a first secondary winding and a second secondary winding. The first H-bridge circuit is connected to a first DC voltage connection at external connections. The center connections of the first H-bridge circuit are electrically coupled to the primary winding of the transformer. The first resonant circuit is electrically connected between the center connections of the first H-bridge circuit and the primary winding of the transformer. The second H-bridge circuit is connected to a second DC voltage connection at the external connections. The center connections of the second H-bridge circuit are electrically coupled to the first secondary winding of the transformer. The voltage converter circuit comprises six semiconductor switching elements and an inductance. A first semiconductor switching element is arranged between a first node point and a first center connection. A second semiconductor switching element is arranged between the first center connection and a first external connection. A third semiconductor switching element is arranged between a second node point and a second center connection. A fourth semiconductor switching element is arranged between the second center connection and the first external connection. A fifth switching element is arranged between a second external connection and the first node point. A sixth switching element is arranged between the second external connection and the second node point. The first external connection of the voltage converter circuit is electrically connected to a first connection point of a third DC voltage connection. The inductance is arranged between the second external connection of the voltage converter circuit and a second connection point of the third DC voltage connection. The first center connection and the second center connection of the voltage converter circuit are each electrically connected to connections of the second secondary winding of the transformer.

The following is furthermore provided:

An electric vehicle with a high-voltage electrical system, a low-voltage electrical system and a DC voltage converter according to the invention. In this case, the second DC voltage connection of the DC voltage converter is electrically coupled to the high-voltage electrical system of the electric vehicle. The third DC voltage connection of the DC voltage converter is electrically coupled to the low-voltage electrical system of the electric vehicle. The first DC voltage connection of the DC voltage converter may also be designed to be connected to a charging connection or a charging circuit of the electric vehicle.

Finally, the following is provided:

A method for operating a DC voltage converter according to the invention, wherein the method can respectively carry out one of the following steps. In a first operating mode, the method can transfer electrical energy from the first DC voltage connection to the second DC voltage connection. In a second operating mode, the method can transfer electrical energy from the second DC voltage connection to the third DC voltage connection. In a third operating mode, electrical energy can be transferred from the third DC voltage connection to the second DC voltage connection. In a fourth operating mode, electrical energy can be transferred from the second DC voltage connection to the first DC voltage connection and to the third DC voltage connection. In a fifth operating mode, electrical energy can be transferred from the first DC voltage connection to the, second DC voltage connection and to the third DC voltage connection. Furthermore, in a sixth operating mode, electrical energy can be transferred from the, second DC voltage connection to the first DC voltage connection. In the first and sixth operating modes, the fifth and sixth switching elements of the voltage converter circuit can be open. In the second and third operating modes, the fifth and sixth switching elements of the voltage converter circuit are closed. In the fourth and fifth operating modes, the fifth and sixth switching elements of the voltage converter circuit are actuated as step-down converters.

The present invention is based on the realization that conventional electric vehicles may be equipped with several DC voltage converters. For example, a DC voltage converter can be used to exchange electrical energy between a high-voltage electrical system and a low-voltage electrical system. In addition, another DC voltage converter can be provided between an external energy source and internal on-board systems. This means a significant hardware effort and associated costs.

It is therefore an idea of the present invention to create a DC voltage converter that can realize an exchange of electrical energy between more than two connections. In particular, it is desirable to realize a cost-effective and efficient DC voltage converter for exchanging energy between more than two DC voltage connections.

According to the invention, a DC voltage converter is provided with three DC voltage connections. In this case, the electrical energy can be exchanged between the individual DC voltage connections in almost any configuration. For example, a first DC voltage connection can be provided to be connected to an external energy source, for example a charging connection of an electric vehicle. Either a DC voltage can be provided directly at the charging connection, or alternatively, an AC voltage that has been provided can be rectified by means of a rectifier and then the rectified voltage can be provided at the first DC voltage connection. A second DC voltage connection can, for example, be designed to be connected to a high-voltage electrical system of an electric vehicle. Such a high-voltage electrical system may, for example, comprise a traction battery and an electric drive system and possibly other consumers. The high-voltage electrical system usually has an electrical voltage of several hundred volts, for example 400 V or 800 V. A third DC voltage connection of the rectifier may, for example, be designed to be connected to a low-voltage electrical system of an electric vehicle. In such a low-voltage electrical system, for example, electrical consumers such as sensors, actuators, control devices, components of comfort functions, an entertainment system or similar may be provided. Furthermore, an electrical energy storage device in the form of a rechargeable battery can also be provided in this low-voltage electrical system. The low-voltage electrical system can have an electrical voltage that is significantly lower than the electrical voltage in the high-voltage system. For example, the electrical voltage in the low-voltage electrical system can be 12 to 14 V, 24 V or 48 V.

The half-bridge circuits of the rectifier may, for example, comprise two half-bridges with two semiconductor switching elements each. The semiconductor switching elements may be, for example, MOSFETs or bipolar transistors with an insulated gate connection (IGBT). A half-bridge comprises two series-connected semiconductor switching elements. The two semiconductor switching elements are electrically connected to each other at a center connection. The other connections, referred to here as external connections, are connected to the corresponding connection points of the respective DC voltage connections. The center connections are connected either directly or via an resonant circuit to the connections of the corresponding transformer windings.

The resonant circuit can, for example, comprise a coil or inductance connected in series and a capacitor or capacitance. Alternatively, an inductance can also be provided, for example, between a center connection and a corresponding connection of the transformer winding, and a capacitance can be provided between the other center connection and the corresponding connection of the transformer winding. Of course, any other configurations of resonant circuits are also possible. If necessary, the resonant circuit can also consist of only one capacitance or one inductance.

The voltage converter circuit, which is provided between the second secondary winding and the third DC voltage connection, comprises, in addition to the components of an H-bridge, two further switching elements (fifth and sixth switching elements) and an inductance. These additional components can be used to implement the functionality of a step-down converter.

This makes it possible to adjust the electrical voltage at the third DC voltage connection in a suitable manner when electrical energy is transferred to the third DC voltage connection through these components of the step-down converter.

Thus, a transmission of electrical energy between the three DC voltage connections can be realized in an efficient manner, wherein the electrical voltage at the individual connections can be set or controlled in a targeted manner.

According to one embodiment, the first semiconductor switching element and the fifth semiconductor switching element are complementary semiconductor switching elements. Similarly, the second semiconductor switching element and the sixth semiconductor switching element are complementary semiconductor switching elements. The first, second, third and fourth semiconductor switching elements may be the same or at least similar semiconductor switching elements. For example, a complementary semiconductor switching element to an n-channel transistor is a p-channel transistor and vice versa. In particular, complementary semiconductor switching elements have opposite blocking or conducting directions when open. The semiconductor switching elements may be, for example, MOSFETs or bipolar transistors with an insulated gate connection (IGBT). In principle, hybrid forms are also conceivable, in which, for example, the first to fourth semiconductor switching elements are designed as IGBTs and the fifth to sixth semiconductor switching elements are designed as MOSFETs.

According to one embodiment, the first H-bridge circuit and the second H-bridge circuit each comprise four semiconductor switching elements. The four semiconductor switching elements are particularly designed in the form of two half-bridges. In each case, a first semiconductor switching element is arranged between a first external connection and a first center connection of the respective H-bridge circuit. A second semiconductor switching element is arranged between the first external connection and a second center connection of the respective H-bridge circuit. A third semiconductor switching element is arranged between a second external connection and the first center connection of the respective H-bridge circuit. A fourth semiconductor switching element is arranged between the second external connection and the second center connection of the respective H-bridge circuit.

According to one embodiment, the DC voltage converter comprises a second resonant circuit. The second resonant circuit is electrically connected between the center connections of the second H-bridge circuit and the first secondary winding of the transformer. Similar to the first resonant circuit, the second resonant circuit can also comprise capacitance and inductance. For example, a series connection consisting of a capacitance and an inductance can be provided between a center connection of the second H-bridge circuit and the corresponding connection of the first secondary winding of the transformer. Alternatively, a capacitance can be arranged between the first center connection of the second H-bridge circuit and the corresponding connection of the first secondary winding of the transformer, and the inductance can be arranged between the second center connection and the corresponding connection of the first secondary winding of the transformer. Alternatively, the second resonant circuit can also comprise only a capacitance, which is arranged between a center connection of the second H-bridge circuit and the corresponding connection of the first secondary winding of the transformer.

According to one embodiment, the DC voltage converter comprises a control device. The control device is designed to actuate the semiconductor switching elements of the first H-bridge circuit, the second H-bridge circuit and the voltage converter circuit in the DC voltage converter. In particular, the control can be carried out, for example, by means of pulse-width modulated control signals. The control device can be designed to match a frequency and/or phase of an alternating voltage appearing at the primary winding and/or the first secondary winding of the transformer in a resonant operation.

According to a further embodiment, the control device can be designed to actuate the fifth and/or sixth semiconductor switching element of the voltage converter circuit in a step-down converter mode.

According to one embodiment, the DC voltage converter is designed to transfer electrical energy from the first DC voltage connection to the second DC voltage connection in a first operating mode. For example, this can transfer electrical energy from a power source connected to the first DC voltage connection to a traction battery of an electric vehicle connected to the second DC voltage connection in order to charge the traction battery. In particular, the DC voltage converter can be operated in a resonant operation corresponding to the resonant frequency of the first resonant circuit. Furthermore, the DC voltage converter can be designed to transfer electrical energy from the second DC voltage connection to the third DC voltage connection in a second operating mode. If a second resonant circuit is provided between the second H-bridge circuit and the first secondary winding of the transformer, the DC voltage converter can also be operated in a resonant operating mode here. In this second operating mode, for example, electrical energy can be transferred from a traction battery of an electric vehicle connected to the second DC voltage connection to a low-voltage electrical system of the electric vehicle connected to the third DC voltage connection. In this case, the fifth and sixth switching elements of the voltage converter circuit can both be closed. Furthermore, the DC voltage converter can be designed to transfer electrical energy from the third DC voltage connection to the second DC voltage connection in a third operating mode. In this case, the fifth and sixth switching elements of the voltage converter circuit can be closed. In this third operating mode, for example, electrical energy can be transferred from the low-voltage electrical system of an electric vehicle to the high-voltage electrical system of the electric vehicle at the second DC voltage connection in order to charge an DC intermediate circuit in the high-voltage electrical system. Furthermore, the DC voltage converter can be designed to transfer electrical energy from the second DC voltage connection simultaneously to the first DC voltage connection and to the third DC voltage connection in a fourth operating mode. In this fourth operating mode, the fifth and sixth switching elements of the voltage converter circuit can be actuated together with the inductance of the voltage converter circuit as a step-down converter. In this way, both the electrical voltage at the first DC voltage connection and at the third DC voltage connection can be set to predetermined setpoint values Furthermore, the DC voltage converter can be designed to transfer electrical energy from the first DC voltage connection to the second DC voltage connection and simultaneously to the third DC voltage connection in a fifth operating mode. In this case, the fifth and/or sixth switching element of the voltage converter circuit can be actuated as a step-down converter. Finally, the DC voltage converter can be designed to transfer electrical energy from the second DC voltage connection to the first DC voltage connection in a sixth operating mode. In this case, both the fifth and the sixth switching element of the voltage converter circuit are closed.

The above embodiments and further developments can be combined with one another in any desired manner insofar as advantageous. Additional embodiments, further developments, and implementations of the invention also include inventive feature combinations not described or explicitly specified hereinabove or hereinafter with respect to exemplary embodiments. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings. Shown are:

FIG. 1: a schematic illustration of a block diagram of a DC voltage converter according to one embodiment;

FIG. 2: a schematic illustration of a block diagram of an H-bridge circuit in a DC voltage converter according to one embodiment;

FIG. 3: a schematic illustration of a block diagram of a DC voltage converter according to another embodiment; and

FIG. 4: a flowchart on which a method for operating a DC voltage converter according to one embodiment is based.

### DETAILED DESCRIPTION

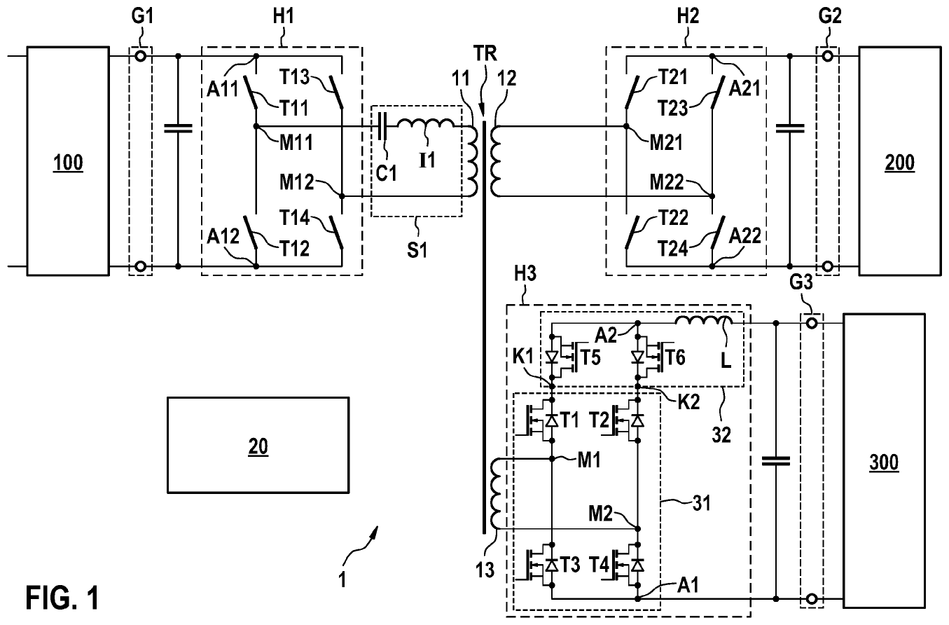

FIG. 1 shows a schematic illustration of a block diagram of a DC voltage converter 1 according to one embodiment. The DC voltage converter 1 comprises three DC voltage connections G1, G2 and G3. If such a DC voltage converter 1 is used, for example, in an electric vehicle, an external energy source, for example a charging station, can be connected to the first DC voltage connection G1. If this charging station already provides a DC voltage, the charging voltage provided can be supplied directly to the first DC voltage connection G1, optionally via a suitable circuit breaker. If the external energy source provides a single-phase or multiphase AC voltage, this can be converted into a DC voltage using a rectifier or another suitable charging circuit 100, if necessary, and the DC voltage can be provided at the first DC voltage connection G1.

A high-voltage electrical system 200 of an electric vehicle, for example, can be connected to the second DC voltage connection G2. Such a high-voltage electrical system 200 can, for example, comprise a traction battery, an electric drive system or any other electrical consumers. The high-voltage electrical system usually has an electrical voltage of several hundred volts, for example 350 to 400 V or 800 V.

A low-voltage electrical system 300 of an electric vehicle, for example, can be connected to the third DC voltage connection G3. In this low-voltage electrical system 300, for example, electrical consumers such as control devices, sensors, actuators, components for comfort functions in an electric vehicle, an entertainment system or similar can be connected. An electrical energy store, for example a lead battery or similar, can also be provided in this low-voltage electrical system 300. The low-voltage electrical system 300 usually has an electrical voltage that is significantly lower than the electrical voltage in the high-voltage electrical system 200. For example, the electrical voltage in the low-voltage electrical system 300 can be 12 to 14 V, 24 V or 48 V.

The DC voltage converter 1 is designed to exchange electrical energy between the three DC voltage connections Gl, G2 and G3. A transformer TR is provided in the DC voltage converter 1 for this purpose. In this way, the individual DC voltage connections Gl, G2 and G3 can be galvanically isolated from each other.

The transformer TR comprises a primary winding 11, a first secondary winding 12 and a second secondary winding 13. Furthermore, the DC voltage converter 1 comprises a first H-bridge circuit H1, a second H-bridge circuit H2 and a voltage converter circuit H3. The basic structure of an H-bridge circuit Hl, H2 will be explained in more detail below.

The two external connections A11, A12 of the first H-bridge circuit H1 are electrically connected to corresponding connection points of the first DC voltage connection G1. The two center connections M11, M12 of the first H-bridge circuit H1 are connected to the two connections of the primary winding 11 via a first resonant circuit S1.

The first resonant circuit S1 can, for example, comprise a first capacitance C1 and a first inductance I1. For example, the first capacitance C1 can be provided between a first center connection M11 of the first H-bridge circuit H1 and a corresponding connection of the primary winding 11. Furthermore, the first inductance I1 can be provided between the second center connection M12 of the first half-bridge H1 and the further connection of the primary winding 11. Alternatively, it is also possible to provide a series connection consisting of the first capacitance C1 and the first inductance I1 between a center connection M11, M12 of the first half-bridge H1 and a connection of the primary winding 11. Furthermore, other suitable arrangements of resonant components for the first resonant circuit S1 are also possible.

The second H-bridge circuit H2 is electrically connected to the two external connections with the corresponding connection points of the second DC voltage connection G2. The two center connections of the second H-bridge circuit H2 are connected to the two connections of the first secondary winding 12 of the transformer TR. If necessary, further resonant components can be provided between the connection points of the first secondary winding 12 of the transformer TR and the center connections of the second H-bridge circuit H2. This will be explained in more detail below.

The voltage converter circuit H3 is arranged between the third DC voltage connection G3 and the second secondary winding 13 of the transformer TR. The voltage converter circuit H3 comprises six semiconductor switching elements T1 to T6 and an inductance L. If necessary, a (parasitic) inductance of the second secondary winding 13 of the transformer TR can optionally be used in addition to or as an alternative to this discrete inductance.

A first semiconductor switching element T1 is arranged between a first node point K1 and a first center tap M1 of the voltage converter circuit H3. The second switching element T2 is arranged between the first center connection M1 and a first external connection A1 of the voltage converter circuit H3. A third switching element T3 is arranged between a second node point K2 and a second center connection M2 of the voltage converter circuit H3. A fourth switching element T4 is arranged between the second center connection M2 and the first external connection A1.

Furthermore, a fifth semiconductor switching element T5 is arranged between a second external connection A2 and the first node point K1 of the voltage converter circuit H3. Finally, a sixth semiconductor switching element T6 is arranged between the second external connection A2 and the second node point K2.

The first external connection A1 is electrically connected to a first connection point of the third DC voltage connection G3. The inductance L is arranged between the second external connection A2 of the voltage converter circuit H3 and the second connection point of the DC voltage connection G3.

In this way, the voltage converter circuit H3 forms a combination of a third H-bridge circuit 31 and a step-down converter 32.

The switching elements T1 to T6 of the voltage converter circuit H3, as well as the switching elements of the first half-bridge circuit H1 and the second half-bridge circuit H2, can be actuated by a control device 20 in a suitable manner. In this way, electrical energy can be exchanged between the DC voltage connections Gl, G2 and G3 in almost any desired manner. To regulate the energy transfer, current and/or voltage sensors (not shown) can optionally be provided in the DC voltage converter 1. The sensor values of these current or voltage sensors can be made available at the control device 20. The control device 20 then uses a setpoint specification for the energy transfer and the output voltages to be set to generate control signals for the switching elements in the first half-bridge circuit Hl, the second half-bridge circuit H2 and the voltage converter circuit H3. These control signals can optionally be provided via suitable driver stages at the corresponding switching elements.

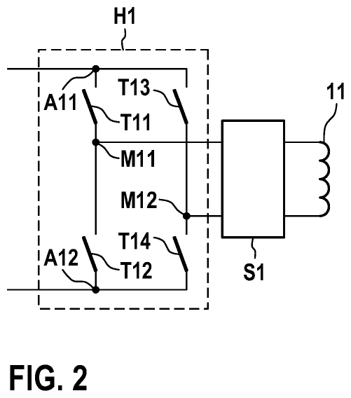

FIG. 2 shows a schematic illustration of a block diagram of a half-bridge circuit, such as can be used, for example, as the first half-bridge circuit H1 or the second half-bridge circuit H2 in a rectifier 1 according to the invention. Even if the following description is given in connection with the first half-bridge circuit H1, it applies analogously to the second half-bridge circuit H2.

As shown in FIG. 2, the first half-bridge circuit H1 comprises two half-bridges, each having two series-connected semiconductor switching elements T11 to T14. A first semiconductor switching element T11 is arranged between a first external connection A11 and a first center connection M11. A second semiconductor switching element T12 is arranged between the first center connection M11 and a second external connection A12. A third semiconductor switching element T13 is arranged between the first external connection A11 and a second center connection M12. A fourth semiconductor switching element T14 is arranged between the second center connection M12 and the second external connection A12. The two external connections A11 and A12 are connected to the corresponding connections of the primary winding 11 of the transformer TR via the first resonant circuit S1.

The second half-bridge circuit H2 is constructed analogously to the circuit principle described above with the four semiconductor switching elements T21 to T24. The semiconductor switching elements T21 to T24 are consequently arranged between the external connections A21 and A22 and the center connections M21 and M22.

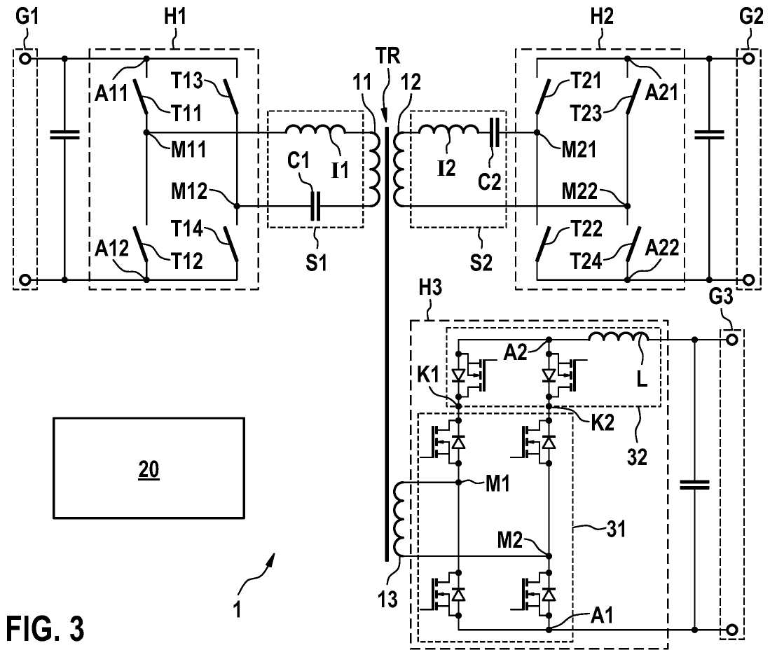

FIG. 3 shows a schematic illustration of a block diagram of a DC voltage converter 1 according to a further embodiment. In this case, all of the statements already made in connection with FIGS. 1 and 2 apply, where applicable. The DC voltage converter 1 according to FIG. 3 differs in particular in that a second resonant circuit S2 is provided between the first secondary winding 12 of the transformer TR and the second half-bridge circuit H2. This resonant circuit can, for example, comprise a second capacitance C2 and a second inductance 12. For example, a series connection comprising the second capacitance C2 and the second inductance 12 may be provided between a connection point of the first secondary winding 12 of the transformer TR and a center connection of the second half-bridge circuit H2. Alternatively, the second capacitance C2 can be provided between a connection of the first secondary winding 12 of the transformer TR and a first center connection of the second half-bridge H2, and the second inductance 12 can be provided between a further connection of the first secondary winding 12 of the transformer TR and a second center connection of the second half-bridge H2. Optionally, the second resonant circuit S2 can also be just a capacitance C2 between a connection of the first secondary winding 12 of the transformer TR and a center connection of the second half-bridge circuit H2.

To transmit electrical energy between the DC voltage connections Gl, G2 and G3, the switching elements of the first half-bridge circuit H1 and of the second half-bridge circuit H2 can be actuated such that an electrical AC voltage is present at the windings of the transformer TR, wherein the frequency and/or phase of these alternating voltages can be adjusted taking into account a resonant frequency of the first resonant circuit S1 and/or of the second resonant circuit S2. In this way, a resonant operating mode can be set in the DC voltage converter 1. However, since the basic principle of such a resonant operation is assumed to be known, it will not be explained in detail here.

Various operating modes are possible for the exchange of electrical energy between the DC voltage connections Gl, G2 and G3. Some exemplary operating modes are explained in more detail below with reference to the method according to the invention for operating a DC voltage converter 1.

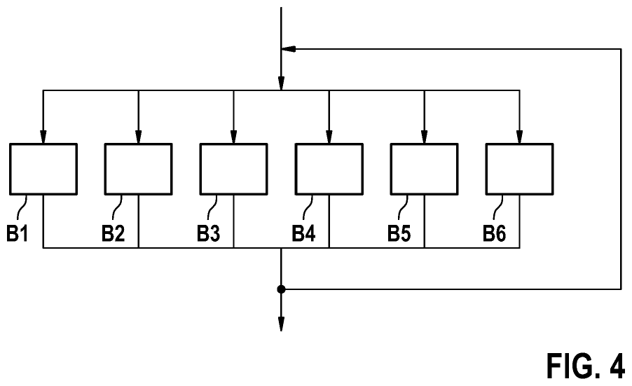

FIG. 4 shows a flowchart that can underlie a method for operating a DC voltage converter 1, in particular one of the DC voltage converters 1 described above, according to one embodiment.

To operate the DC voltage converter 1, the control device 20 can control the switching elements in the H-bridge circuits H1, H2 and/or in the voltage converter circuit H3 in a suitable manner. For this purpose, for example, a pulse-width modulated control can be carried out in order to set the desired electrical voltage in terms of amplitude, frequency and phase at the respective primary and secondary windings 11, 12, 13.

In a first operating mode B1, for example, electrical energy can be transferred from the first DC voltage connection G1 to the second DC voltage connection G2. In this case, the fifth switching element T5 and the sixth switching element T6 of the voltage converter circuit H3 can be open. In this way, the third DC voltage connection G3 is electrically isolated from the second secondary winding 13 of the transformer TR. In order to transfer energy from the first DC voltage connection Gl to the second DC voltage connection G2, an AC voltage can be generated in a resonant operating mode, the frequency and/or phase of which is set taking into account a resonant frequency of the first resonant circuit S1. In such a first operating mode B1, for example, electrical energy can be transferred from an energy source connected to the first DC voltage connection Gl to a traction battery connected to the second DC voltage connection G2, for example in order to charge the traction battery.

In a second operating mode B2, for example, electrical energy can be transferred from the second DC voltage connection G2 to the third DC voltage connection G3. In this way, for example, electrical energy can be transferred from a traction battery in the high-voltage system of an electric vehicle to a low-voltage system of the electric vehicle. If a second resonant circuit S2 is provided between the second half-bridge circuit H2 and the first secondary winding 12 of the transformer TR, then resonant operation can also be set up here, taking into account the resonant frequency of the second resonant circuit S2. To transmit electrical energy from the second DC voltage connection G2 to the third DC voltage connection G3, the fifth switching element T5 and the sixth switching element T6 are both closed.

In a third operating mode B3, electrical energy can be transferred from the third DC voltage connection G3 to the second DC voltage connection G2. This can be used, for example, to charge an DC intermediate circuit located in the high-voltage electrical system connected to the second DC voltage connection G2. Here, too, both the fifth switching element T5 and the sixth switching element T6 are closed. To transfer the electrical energy from the third DC voltage connection G3 to the second DC voltage connection G2, the switching elements T1-T4 in an H-bridge circuit 31 of the voltage converter circuit H3 can be actuated, for example, according to the principle of a dual active bridge. Since this switching principle is also assumed to be known, it will not be discussed in more detail here.

In a fourth operating mode B4, for example, electrical energy can be transferred from the second DC voltage connection G2 to the first DC voltage connection Gl and simultaneously to the third DC voltage connection G3. In this case, the DC voltage converter 1 is operated in a resonant operating mode such that an electrical DC voltage to be set is present at the first DC voltage connection Gl. The fifth switching element T5 and the sixth switching element T6, as well as the inductance L of the voltage converter circuit H3, form a step-down converter 32. Thus, by appropriately driving the fifth switching element T5 and the sixth switching element T6 of this step-down converter 32, the control device 20 can adjust the electrical voltage at the third DC voltage connection G3 in accordance with a prescribed setpoint.

In a fifth operating mode B5, electrical energy can be transferred from the first DC voltage connection Gl to the second DC voltage connection G2 and simultaneously from the first DC voltage connection Gl to the third DC voltage connection G3. Here too, in a resonant operating mode, the electrical voltage at the second DC voltage connection G2 is first set in accordance with a setpoint value. In addition, the electrical voltage at the third DC voltage connection G3 can also be set here by suitably controlling the fifth switching element T5 and the sixth switching element T6 in the step-down converter circuit 32 of the voltage converter circuit H3.

Finally, in a sixth operating mode B6, electrical energy can be transferred from the second DC voltage connection G2 to the first DC voltage connection Gl and simultaneously to the third DC voltage connection (G3). Here, too, a resonant operating mode can be selected if necessary. In this case, the fifth switching element T5 and the sixth switching element T6 of the voltage converter circuit H3 are open.

In summary, the present invention relates to a DC voltage converter with three DC voltage connections. This allows electrical energy to be exchanged between the three DC voltage connections in almost any way. The DC voltage converter comprises an resonant circuit for resonant operation. Furthermore, a combination of an H-bridge circuit and a step-down converter is provided at least at one DC voltage converter connection.

1. A DC voltage converter (1) comprising:
a transformer (TR) having a primary winding (11), a first secondary winding (12), and a second secondary winding (13);
a first H-bridge circuit (H1) connected at external connections (A11, A12) to a first DC voltage connection (G1) and electrically coupled at center connections (M11, M12) to the primary winding (11) of the transformer (TR);
a first resonant circuit (S1) electrically arranged between the center connections (M11, M12) of the first H-bridge circuit (H1) and the primary winding (11) of the transformer (TR);
a second H-bridge circuit (H2) which is connected at external connections to a second DC voltage connection (G2) and is electrically coupled at center connections to the first secondary winding (12) of the transformer (TR); and
a voltage converter circuit (H3), wherein a first semiconductor switching element (T1) is arranged between a first node point (K1) and a first center connection (M1), a second semiconductor switching element (T2) is arranged between the first center connection (M1) and a first external connection (A1), a third semiconductor switching element (T3) is arranged between a second node point (K2) and a second center connection (M2), a fourth semiconductor switching element (T4) is arranged between the second center connection (M2) and the first external connection (A2), a fifth switching element (T5) is arranged between a second external connection (A2) and the first node point (K1), a sixth switching element (T6) is arranged between the second external connection (A2) and the second node point (K2), and
wherein the first external connection (A1) is electrically connected to a first connection point of a third DC voltage connection (G3), an inductance (L) is arranged between the second external connection (A2) and a second connection point of the third DC voltage connection (G3), and the first center connection (M1) and the second center connection (M2) are each electrically connected to connections of the second secondary winding (13) of the transformer (TR).

2. The DC voltage converter (1) according to claim 1, wherein the first semiconductor switching element (T1) and the fifth semiconductor switching element (T5) of the voltage converter circuit (H3) are complementary semiconductor switching elements, and the second semiconductor switching element (T2) and the sixth semiconductor switching element (T6) of the voltage converter circuit (H3) are complementary semiconductor switching elements.

3. The DC voltage converter (1) according to claim 1, wherein the first H-bridge circuit (H1) and the second H-bridge circuit (H2) each comprise a first semiconductor switching element (T11, T21), which is arranged between a first external connection (A11, A21) and a first center connection (M11, M21) of the respective H-bridge circuit (H1, H2), a second semiconductor switching element (T12, T22), which is arranged between the first external connection (A11, A21) and a second center connection (M12, M22) of the respective H-bridge circuit (H1, H2), a third semiconductor switching element (T13, T23), which is arranged between a second external connection (A12, A22) and the first center connection (M11, M21) of the respective H-bridge circuit (H1, H2), and a fourth semiconductor switching element (T14, T24), which is arranged between the second external connection (A12, A22) and the second center connection (M12, M22) of the respective H-bridge circuit (H1, H2).

4. The DC voltage converter (1) according to claim 1, having a second resonant circuit (S2) which is arranged electrically between the center connections (M21, M22) of the second H-bridge circuit (H2) and the first secondary winding (12) of the transformer (TR).

5. The DC voltage converter (1) according to claim 1, having a control device (20) which is configured to actuate the semiconductor switching elements (T11-T14, T21-T24, T1-T6) of the first H-bridge circuit (H1), the second H-bridge circuit (H2), and the voltage converter circuit (H3),
wherein the control device (20) is configured to match a frequency and/or a phase of an electrical alternating voltage appearing across the primary winding (11) and/or one of the secondary windings (12, 13) in a resonant operation.

6. The DC voltage connection (1) according to claim 5, wherein the control device (20) is configured to actuate the fifth and/or sixth semiconductor switching element (T5, T6) of the voltage converter circuit (A1) in a step-down converter mode.

7. The DC voltage converter (1) according to claim 1, wherein the DC voltage converter (1) is configured to
transfer electrical energy from the first DC voltage connection (G1) to the second DC voltage connection (G2) in a first operating mode,
transfer electrical energy from the second DC voltage connection (G2) to the third DC voltage connection (G3) in a second operating mode,
transfer electrical energy from the third DC voltage connection (G3) to the second DC voltage connection (G2) in a third operating mode,
transfer electrical energy from the second DC voltage connection (G2) to the first DC voltage connection (G1) and to the third DC voltage connection (G3) in a fourth operating mode,
transfer electrical energy from the first DC voltage connection (G1) to the second DC voltage connection (G2) and the third DC voltage connection (G3) in a fifth operating mode, and
transfer electrical energy from the second DC voltage connection (G3) to the first DC voltage connection (B1) in a sixth operating mode;
wherein the fifth and sixth switching elements (T5, T6) of the voltage converter circuit (H3) are open in the first and sixth operating modes, closed in the second and third operating modes, and actuated as a step-down converter in the fourth and fifth operating modes.

8. An electric vehicle comprising
a high-voltage electrical system (200);
a low-voltage electrical system (300); and
a DC voltage converter (1) according to claim 1;
wherein the second DC voltage connection (G2) of the DC voltage converter (1) is electrically coupled to the high-voltage electrical system (2) of the electric vehicle, and the third DC voltage connection (G3) of the DC voltage converter (1) is electrically coupled to the low-voltage electrical system (300) of the electric vehicle.

9. An electric vehicle according to claim 8, comprising a rectifier (100) adapted to be coupled at an AC voltage input to a single-phase or multiphase AC voltage source and electrically coupled at a DC voltage output to the first DC voltage connection (G1) of the DC voltage converter (1).

10. A method for operating a DC voltage converter (1) according to claim 1, wherein during operation of the DC voltage converter (1) one of the following steps is carried out in each case:
transferring (B1) electrical energy from the first DC voltage connection (G1) to the second DC voltage connection (G2) in a first operating mode;
transferring (B2) electrical energy from the second DC voltage connection (G2) to the third DC voltage connection (G3) in a second operating mode;
transferring (B3) electrical energy from the third DC voltage connection (G3) to the second DC voltage connection (G2) in a third operating mode;
transferring (B4) electrical energy from the second DC voltage connection (G2) to the first DC voltage connection (G1) and to the third DC voltage connection (G3) in a fourth operating mode;
transferring (B5) electrical energy from the first DC voltage connection (G1) to the second DC voltage connection (G2) and to the third DC voltage connection (G3) in a fifth operating mode; or
transferring (B6) electrical energy from the second DC voltage connection (G2) to the first DC voltage connection (G1) in a sixth operating mode;
wherein the fifth and sixth switching elements (T5, T6) of the voltage converter circuit (H3) are open in the first and sixth operating modes, closed in the second and third operating modes, and actuated as a step-down converter in the fourth and fifth operating modes.
